(19) United States
(12) Patent Application Publication
(10) Pub. No.: US 2016/0004475 A1
(43) Pub. Date: Jan. 7, 2016

(54) MANAGEMENT SYSTEM AND METHOD OF DYNAMIC STORAGE SERVICE LEVEL MONITORING

(71) Applicant: HITACHI, LTD, Tokyo (JP)

(72) Inventors: Nobuo BENIYAMA, Santa Clara, CA (US); Sathish RAGHUNATHAN, Santa Clara, CA (US); Nitin WILSON, Santa Clara, CA (US); Ashutosh DAS, San Jose, CA (US)

(21) Appl. No.: 14/769,193

(22) PCT Filed: Feb. 28, 2013
(86) PCT No.: PCT/IB2013/001156

§ 371 Date: Aug. 20, 2015

(51) Int. Cl. G06F 3/06

(52) U.S. Cl. CPC G06F 3/0653; G06F 3/0613; G06F 3/0611; G06F 3/067

(57) ABSTRACT

To manage a storage system for storing write data of I/O (Input/Output) command to a storage volume, a computer program comprises: code for analyzing performance information of I/O operation for a period of time on a storage volume basis; code for deriving a periodic time window having a same type of I/O performance characteristic; code for determining a type of Service Level Objectives (SLO) on a periodic time window basis; code for calculating a threshold value of the SLO; code for providing a user with a type of SLO for a periodic monitoring window and a threshold value of SLO for the periodic monitoring window on a storage volume group basis; and code for monitoring, on a storage volume basis, whether or not a service level value for the periodic monitoring window violates the SLO based on the threshold value of SLO for the periodic monitoring window.

### BACKGROUND OF THE INVENTION

The present invention relates generally to storage utilization by computer applications and, more particularly to management system and method of dynamic storage service level monitoring.

In large datacenters, there are hundreds of thousands of storage devices (a.k.a. volumes) and tens of thousands of servers using those storage devices. The purpose of using high cost storage systems is to get higher level of service (e.g., response time and throughput). Software tools that track performance of these storage devices require users to set a threshold value against which the performance is monitored and alerts are raised when the performance levels do not meet the prescribed thresholds.

### BRIEF SUMMARY OF THE INVENTION

Exemplary embodiments of the invention provide management system and method of dynamic storage service level monitoring. Dynamic storage service level monitoring has a number of challenges including, for example, the following:

1. How to accurately determine SLO (service level objective) parameters.

a. Which volumes should be monitored?

b. When should they be monitored? Because many applications/servers have different modes of operations that have different 10 (input/output) patterns, they may need different service level monitoring.

c. What are the metrics to be monitored and what threshold values should be used?

2. The workload profile of an application using the storage devices is typically very dynamic. Monitoring such devices with a static setting could give inaccurate results.

Heretofore, the management software allows users to manually select the SLO metric to be used for monitoring, the monitoring window (time period to monitor the SLO), and the threshold values. This invention analyzes the historical performance data and determines the SLO parameters for every volume and storage group. These values are presented to the user as recommendations. The user can review the recommendations, analyze background information, and then modify and/or accept the recommended values.

An aspect of the invention is directed to a computer program stored in a computer readable storage medium and executed by a computer being operable to manage a storage system comprising a storage controller and a plurality of storage devices controlled by the storage controller for storing a write data of Input/Output (I/O) command sent from another computer to a storage volume of a plurality of storage volumes of the storage system. The computer program comprises: a code for analyzing performance information of I/O operation for a period of time on a storage volume basis, the performance information of I/O operation of each of the plurality of storage volumes for the period of time being collected from the storage system; a code for deriving, based on the analysis, (i) a periodic time window regarded as having a same type of I/O performance characteristic and (ii) a type of I/O performance characteristic as the same type of I/O performance characteristic characterized as being operated for the periodic time window, the periodic time window and the type of I/O performance characteristic for the periodic time window being derived on a storage volume basis; a code for determining a type of Service Level Objectives (SLO) on a periodic time window basis based on the type of I/O performance characteristic for the periodic time window; a code for calculating a threshold value of the SLO on a periodic time window basis based on the periodic time window, the type of SLO and the performance information of I/O operation; a code for providing a user with (i) a type of SLO for a periodic monitoring window and (ii) a threshold value of SLO for the periodic monitoring window on a storage volume group basis, the periodic monitoring window, the type of SLO for a periodic monitoring window, and the threshold value of SLO for the periodic monitoring window being created by using the periodic time window, the type of SLO for the periodic time window, and the threshold value of SLO for the periodic time window, the storage volume group having a set of storage volumes storing data executed by the same application on said another computer; and a code for monitoring, on a storage volume basis, whether or not a service level value for the periodic monitoring window violates the SLO based on the threshold value of SLO for the periodic monitoring window, wherein the service level value for the periodic monitoring window is derived from performance information of I/O operation operated after the period of time and is of a same type as the type of SLO for the periodic monitoring window, the performance information of I/O operation after the period of time for each of the plurality of storage volumes being collected from the storage system.

In some embodiments, the computer program further comprises: a code for identifying one or more periods of non-normal operation which is not normal operation based on preset normal performance levels of I/O operation; and a code for excluding, from the periodic time window, the one or more periods of non-normal operation. The periodic monitoring window is a periodic time period during which all storage volumes of a monitoring group show the same type of I/O performance characteristic, the monitoring group being a group of storage volumes within the storage volume group. The computer program further comprises a code for deriving one or more periodic time windows for the storage volume group, each periodic time window corresponding to and being associated with a corresponding monitoring group such that all storage volumes of the corresponding monitoring group show the same type of I/O performance characteristic during the corresponding period time window. Each monitoring group is a group of storage volumes within the storage volume group and is identified by a corresponding monitoring group ID.

In specific embodiments, the computer program further comprises: a code for determining whether a storage volume is being monitored or not; a code for, if the storage volume is being monitored, comparing the service level value for the periodic monitoring window with the SLO based on the threshold value of SLO for the periodic monitoring window for the storage volume; and, if the storage volume is not being monitored, analyzing a last periodic time window, deciding whether to start monitoring the storage volume by determining whether a periodic time window is detected or not for the storage volume, if yes, evaluating all service level values for the detected periodic time window's period to determine a type of SLO for the detected period time window, calculate a threshold value of the SLO for the detected periodic time window, and provide the user with a type of SLO for a period monitoring window and a threshold value of SLO for the periodic monitoring window for a storage volume group that includes the storage volume; and a code for, subsequent to the comparing or the evaluating, determining whether or not the service level value for the periodic monitoring window violates the SLO based on the threshold value of SLO for the periodic monitoring window for the storage volume.

In some embodiments, the code for analyzing performance information of I/O operation comprises a code for determining, on a storage volume basis, a type of I/O performance characteristic of a plurality of types which includes (1) sequential I/O if random I/O is below a first threshold, (2) mixed I/O if random I/O is between the first threshold and a second threshold, and (3) random I/O if random I/O is above the second threshold. The type of SLO for random I/O is response time and the type of SLO for sequential I/O is data throughput rate. Deriving a periodic time window comprises specifying that the periodic time window has a sustained I/O duration, during which the same type of I/O performance characteristic is being operated, which is above a preset minimum sustained I/O duration threshold.

Another aspect of the invention is directed to a computer program stored in a computer readable storage medium and executed by a computer being operable to manage a storage system comprising a storage controller and a plurality of storage devices controlled by the storage controller for storing a write data of Input/Output (I/O) command sent from another computer to a storage volume of a plurality of storage volumes of the storage system. The computer program comprises: a code for deriving, on a storage volume basis, (i) a periodic time window regarded as having a same type of I/O performance characteristic, (ii) a type of Service Level Objectives (SLO) for the periodic time window, and (iii) a threshold value of the SLO for the periodic time window by analyzing performance information of I/O operation for a period of time on a storage volume basis, the threshold value of SLO being derived according to the type of SLO, the performance information of I/O operation of each of the plurality of storage volumes for the period of time being collected from the storage system; a code for providing a user with (i) a type of SLO for a periodic monitoring window and (ii) a threshold value of SLO for the periodic monitoring window, the periodic monitoring window, the type of the SLO for the type of SLO, and the threshold value of SLO for the periodic monitoring window being created by using the periodic time window, the type of SLO for the periodic time window, and the threshold value of SLO for the periodic time window; and a code for monitoring whether or not a service level value for the periodic monitoring window violates the SLO based on the threshold value of the SLO of the periodic monitoring window, wherein the service level value for the periodic monitoring window is derived from performance information of I/O operation operated after the period of time and is of a same type as the type of SLO for the periodic monitoring window, the performance information of I/O operation after the period of time for each of the plurality of storage volumes being collected from the storage system.

In accordance with another aspect of this invention, a computer program comprises: a code for managing a storage system comprising a storage controller and a plurality of storage devices controlled by the storage controller for storing a write data of Input/Output (I/O) command sent from a computer to a storage volume of a plurality of storage volumes of the storage system; a code for deriving, on a storage volume basis, (i) a periodic time window regarded as having the same type of I/O performance characteristic, (ii) a type of Service Level Objectives (SLO) for the periodic time window, and (iii) a threshold value of the SLO for the periodic time window by analyzing performance information of I/O operation for a period of time on a storage volume basis, the threshold value of SLO being derived according to the type of SLO, the performance information of I/O operation of each of the plurality of storage volumes for the period of time being collected from the storage system; a code for providing a user with (i) a type of SLO for a periodic monitoring window and (ii) a threshold value of SLO for the periodic monitoring window, the periodic monitoring window, the type of the SLO for the type of SLO, and the threshold value of SLO for the periodic monitoring window being created by using the periodic time window, the type of SLO for the periodic time window, and the threshold value of SLO for the periodic time window; and a code for monitoring whether or not a service level value for the periodic monitoring window violates the SLO based on the threshold value of the SLO of the periodic monitoring window, wherein the service level value for the periodic monitoring window is derived from performance information of I/O operation operated after the period of time and is of a same type as the type of SLO for the periodic monitoring window, the performance information of I/O operation after the period of time for each of the plurality of storage volumes being collected from the storage system.

These and other features and advantages of the present invention will become apparent to those of ordinary skill in the art in view of the following detailed description of the specific embodiments.

### BRIEF DESCRIPTION OF THE DRAWINGS

FIG. 1 illustrates an example of a hardware configuration of a system in which the method and apparatus of the invention may be applied.

FIG. 2 shows an example of the logical layout of provisioned volumes.

FIG. 3 is a table for a database application to illustrate the nature of workloads (workload profiles) for the volumes.

FIG. 4 shows an example of a table of volume performance data.

FIG. 5 shows an example of a storage group volume table.

FIG. 6 shows an example of a SRE sustained IO table.

FIG. 7 shows an example of a SRE time bucket table.

FIG. 8 shows an example of a SRE recommendation table.

FIG. 9 shows an example of a SRE threshold bucket table.

FIG. 10 shows an example of a SRE recommended monitoring groups table.

FIG. 11 shows an example of a SRE monitoring group volume table.

FIG. 12 shows an example of a flow diagram illustrating a process of analyzing volume performance data.

FIG. 13 shows an example of a flow diagram illustrating a process of computing the recommended SLO parameters.

FIG. 14 shows an example of a flow diagram illustrating a process of computing the Time Bucket ID.

FIG. 15 shows an example of a flow diagram illustrating a process of identifying periodicity of workload IO.

FIG. 16 shows an example of a flow diagram illustrating a process of consolidating the SLO threshold values.

FIG. 17 shows an example of a flow diagram illustrating a process of computing monitoring window and monitoring group data.

FIG. 18 shows an example of a flow diagram illustrating a process of basic SLO monitoring.

FIG. 19 shows an example of a list of parameters used in this embodiment of the invention.

FIG. 20 shows an example of an application UI (user interface).

FIG. 21a shows an example of a screen for summary view of SLO recommendations.

FIG. 21b shows an example of a screen for categorized view of SLO recommendations.

FIG. 22 shows an example of a screen for list of monitoring groups.

FIG. 23 shows an example of a screen for view and edit SLO parameters for a monitoring group.

FIG. 24 shows an example of a view of a screen for review SLO recommendation for a volume.

FIG. 25 shows an example of a flow diagram illustrating a process for displaying the view of SLO recommendation—summary view (see FIG. 21a).

FIG. 26 shows an example of a flow diagram illustrating a process for displaying the view of SLO recommendation—categorized view (see FIG. 21b).

FIG. 27 shows an example of a flow diagram illustrating a process for viewing detail information for a volume.

FIG. 28 shows an example of a flow diagram illustrating a process for a user to accept SLO recommendation values.

FIG. 29 shows an example of a flow diagram illustrating a process for a user to edit current values.

FIG. 30 shows an example of port performance data. It lists, for each Port ID, Data Time and Port Processor Busy (%).

FIG. 31 shows an example of RAID Group performance data. It lists, for each RAID Group, Data Time and RG Processor Busy (%).

FIG. 32 shows an example of port to volume mapping data.

FIG. 33 shows an example of RAID Group to volume mapping data.

FIG. 34 shows an example of a flow diagram illustrating a process for identifying degraded performance for port.

FIG. 35 shows an example of a flow diagram illustrating a process for identifying degraded performance for RAID Group.

FIG. 36 shows an example of a flow diagram illustrating a process for dynamic monitoring.

FIG. 37 is a conceptual diagram illustrating an example of the process of the invention.

FIG. 38 is a visual illustration of the analysis of historical performance data for determining SLO parameters.

FIG. 39 shows step 1 of the analysis of FIG. 38.

FIG. 40 shows step 2 of the analysis of FIG. 38.

FIG. 41 shows step 3 of the analysis of FIG. 38.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium including non-transient medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for dynamic storage service level monitoring.

One aspect of the invention is a management module (which may be software or the like) that analyzes historical performance data as well as continuous flow performance data for all the storage devices and identifies: (1) based on the current IO profile, which SLO monitoring should be applied; and (2) what parameters should be used to monitor the SLO (based on current IO type and historical profile). This solution analyzes the existing IO workload and performance level. Assuming that most of the servers and devices are working properly, it captures the IO profiles and the workload patterns to identify which volumes should be monitored, for which metric, when, and by using what threshold values.

In one embodiment, a system includes at least one storage area network (SAN), at least one attached storage system, and a management server. The management server has a host bus adapter (HBA) to connect to the SAN and there is a special storage device provisioned to this server (called command device). Many servers are configured to use storage devices (a.k.a. volumes) from the storage system. All these servers have host bus adapters (HBAs) that connect them to the SAN. Storage devices are provisioned from the storage system to these servers.

The process of the management module (which may be management software) includes the following:

1. The command device is used to collect performance data on all storage system components (volumes, ports, cache, RAID Groups, etc.).

2. The performance metric of each volume is analyzed to identify IO type (random, sequential, etc.)

3. The IO pattern is analyzed to identify periods of sustained IO.

4. The storage array component usage is also analyzed to identify periods of normal operation and periods of high component usage (which may cause degraded performance).

a. High levels of utilization for certain components (e.g., ports and RAID Groups) are not part of normal operation and cause degradation in performance. This typically happens during high load imbalance.

5. The threshold values are calculated using statistical analysis of the data points during the sustained IO periods. Data points that correspond to the high component utilization (step 4) are excluded from the sample as they represent non-normal (degraded) system performance.

6. For each SLO type, the threshold values are bucketed into groups to derive a humanly manageable list of service levels for that specific IO type. For example, for transactional/random IO workload, 5 to 10 response time levels are determined rather than hundreds of different values that vary in fractions of a milliseconds.

7. For a given storage group (consisting of volumes provisioned to a server or application), and a specific SLO type (such as response time or data throughput rate), the different monitoring windows for the member volumes are also grouped to +/−one (1) hour to consolidate the list of monitoring windows.

8. These consolidated SLO levels and monitoring windows are presented to users as the recommended values. The user could accept the recommended values and decide to monitor the storage group with the suggested set of SLOs, could change and accept the SLOs, or could completely ignore them.

9. The user could run the SLO policy recommendation engine on a periodic basis (every month or every quarter) to analyze the change in workload in their storage environment and fine-tune the monitoring levels.

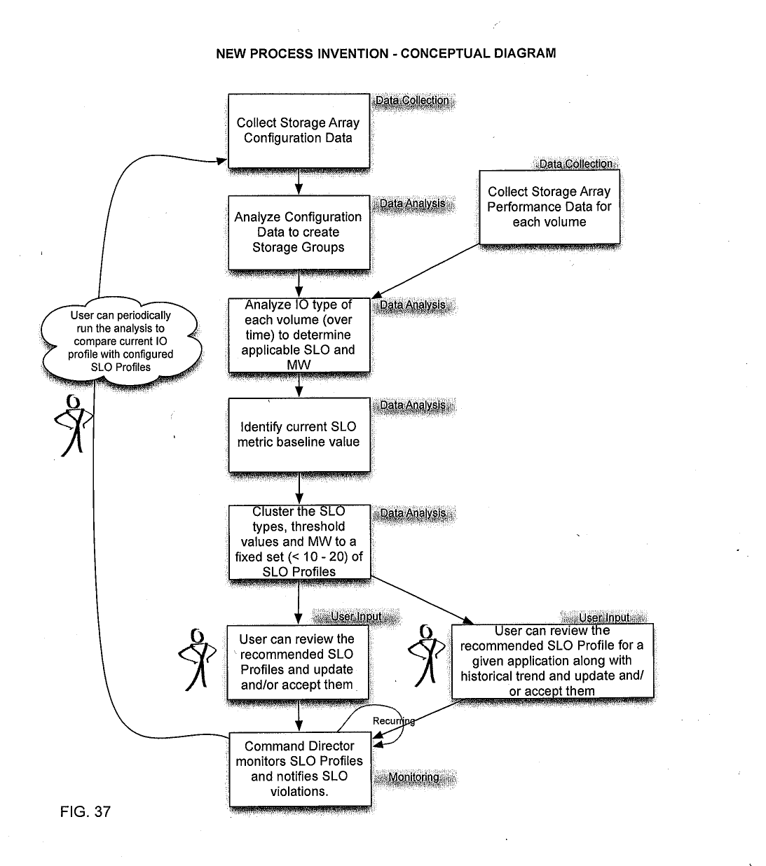

FIG. 37 is a conceptual diagram illustrating an example of the process of the invention. The data collection steps correspond to step 1 above and involves collecting storage array configuration data and collecting storage array performance data for each volume. Three of the data analysis steps correspond to steps 2-5 above and includes analyzing configuration data to create storage groups, analyzing IO type of each volume (over time) to determine applicable SLO and MW (monitoring window), and identifying current SLO metric baseline value. A subsequent data analysis step corresponds to steps 6 and 7 above and involves clustering the SLO types, threshold values, and MWs to a fixed set (e.g., <10-20) of SLO profiles. The user input steps correspond to step 8 above, whereby the user can review the recommended SLO profiles and update and/or accept them, and can review the recommended SLO profile for a given application along with historical trend and update and/or accept them. Finally, step 9 above corresponds to the step in FIG. 37 in which the user can periodically run the analysis to compare current IO profile with configured SLO profiles. FIG. 37 also shows a monitoring step in which the command director monitors SLO profiles and notifies SLO violations.

This invention can be used to plan and monitor the storage environment. The advantage over the common monitoring threshold baselining technology is allowing the user to dynamically apply the appropriate service level monitoring method to meet with changing application I/O behavior, such as OLTP, batch, etc., with simplified monitoring configuration.

### DESCRIPTION OF THE EXAMPLE USED

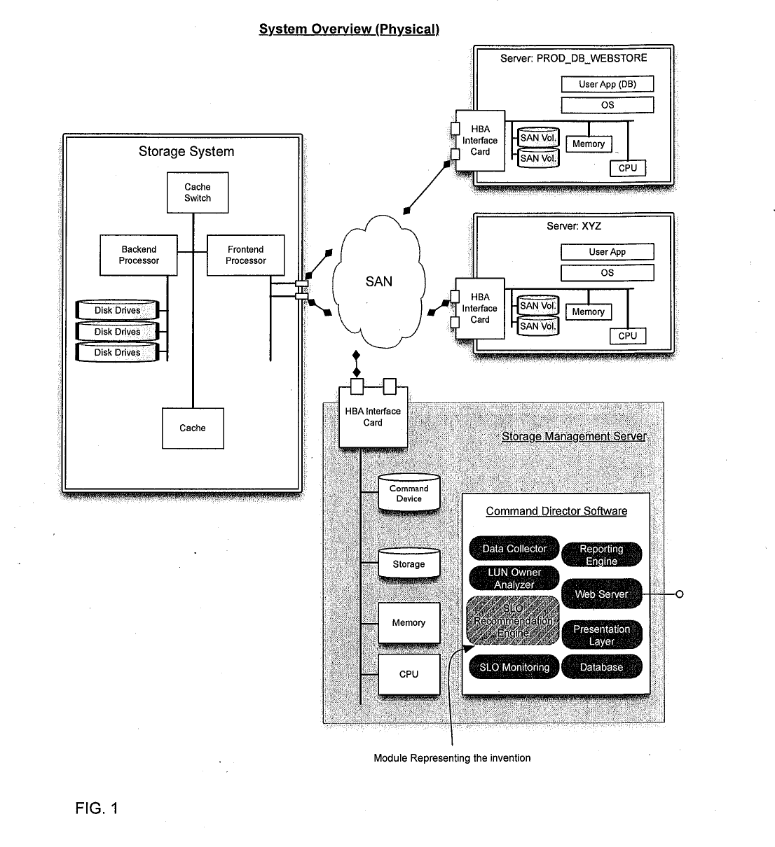

To explain the embodiments, the following example will be used. FIG. 1 illustrates an example of a hardware configuration of a system in which the method and apparatus of the invention may be applied. The system includes a storage system 1001, a server 1002, and a storage management server 1003, which are coupled to a SAN 1004. The storage management server 1003 includes command director software 1005. A production server 1006 (PROD_DB_WEBSTORE) that hosts a production database for the web store app is also coupled to the SAN 1004. This app has three types of volumes: index volumes, data volumes, and transaction log volumes.

The storage system 1001 includes a backend processor (for RAID Groups), a frontend processor (for ports), a cache, a cache switch, and disk drives. The server 1002 includes a CPU (central processing unit), a memory, user app, OS (operating system), and a HBA interface card. The storage management server includes a CPU, a memory, storage, a command device to collect performance data, and a HBA interface card. The command director software 1005 includes a data collector, a LUN owner analyzer, a SLO recommendation engine, a SLO monitoring module, a reporting engine, a Web server, a presentation layer, and a database.

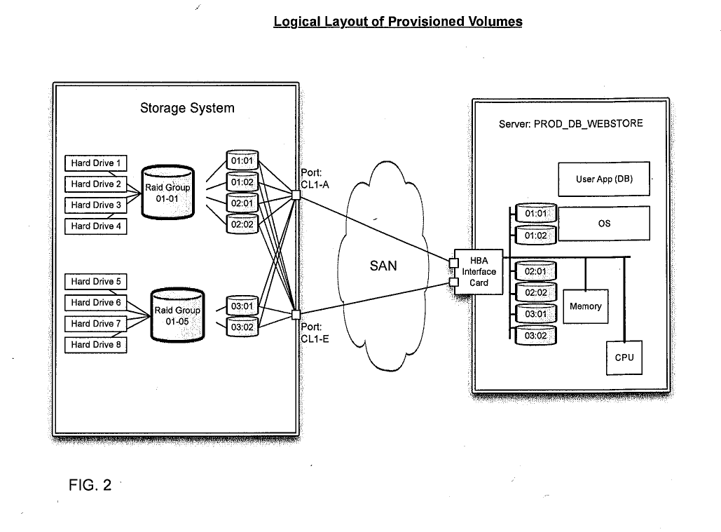

FIG. 2 shows an example of the logical layout of provisioned volumes. In the storage system are RAID Groups (e.g., 01-01 and 01-05). The provisioned volumes include index volumes 01:01 and 01:02, data volumes 02:01 and 02:02, and transaction log volumes 03:01 and 03:02.

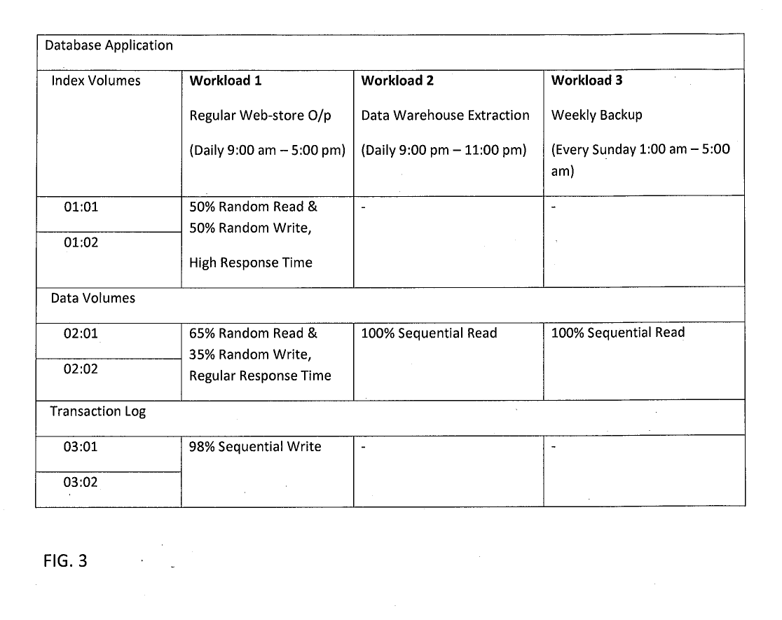

FIG. 3 is a table for a database application to illustrate the nature of workloads (workload profiles) for the volumes. Under Workload 1 (daytime), the index volumes have 50% random read and 50% random write at a high response time, the data volumes have 65% random read and 35% random write at a regular response time, and the transaction log volumes have 98% sequential write. Under Workload 2 (evening), the data volumes have 100% sequential read. Under workload 3 (late night), the data volumes have 100% sequential read.

The index volumes hold the database indexes and thus have small but fast random reads and writes. The data volumes hold the actual data. During the regular web operations (Workload 1), these volumes have a random access pattern. During the de-staging of data for data warehouse (Workload 2) and backup operation (Workload 3), the workload is predominantly sequential read. The transaction Log volumes are for primarily writing the transaction logs (Workload 1). During data maintenance, these logs may be read. The predominant workload pattern is sequential write.

In terms of windows of activity, U.S. companies use this web store and thus there is regular activity primarily from 9:00 am to 5:00 pm. (Workload 1). Every night from 9 pm to 11 pm, there is data de-staging to data warehouse application (Workload 2). Every morning from 1 am to 3 am, there is incremental database backup operation (Workload 3). On Sunday mornings 1:00 am to 5:00 am there is a scheduled full backup.

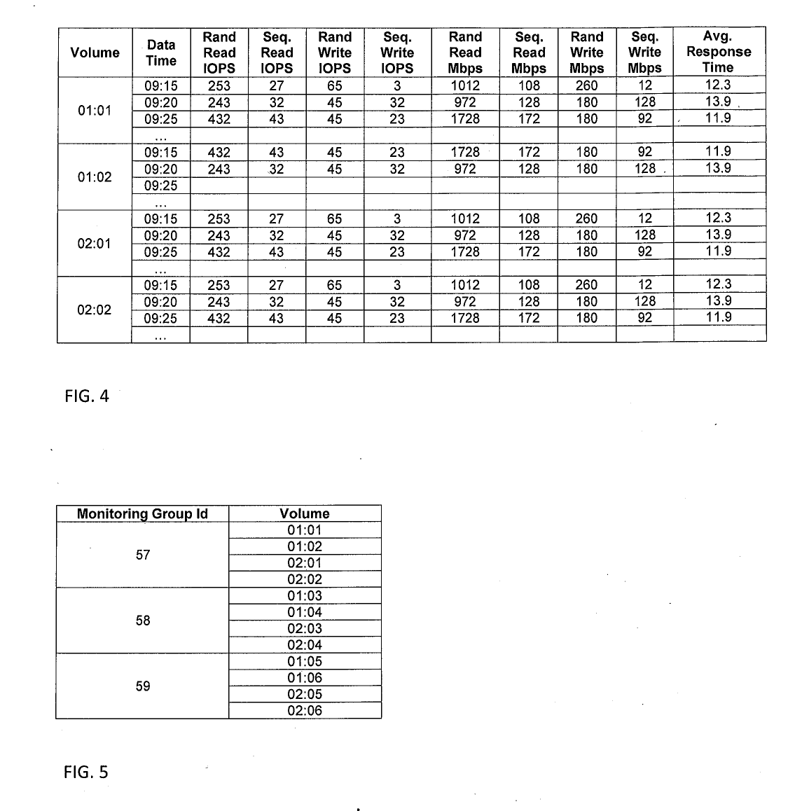

FIG. 4 shows an example of a table of volume performance data. The table shows, for each Volume, Data Time, Random Read IOPS (Input/Output Operations Per Second), Sequential Read IOPS, Random Write IOPS, Sequential Write IOPS, Random Read Mbps (Megabits per second), Sequential Read Mbps, Random Write Mbps, Sequential Write Mbps, and Average Response Time.

The rationale behind dynamic SLO monitoring logic is that it is very difficult to accurately estimate the SLO parameters (type of SLO, threshold values, and monitoring window) for all SAN volumes in a data center, which could range from few tens of thousands to few million volumes. Therefore, during the normal operation of these servers/applications and the related SAN volumes, the SLO parameters are evaluated and then those values are used for monitoring the same volumes. The idea is to monitor the environment and alert users when these volumes are violating the SLO thresholds that were set based on the normal operations.

In this description, a storage group is a group of volumes that are provisioned to the same server or cluster. This grouping is derived from the volume path information configured in the storage system. A monitoring group is a sub-group of volumes, within a storage group, that exhibit the same IO workload characteristics (e.g., same type of IO and similar levels of IO response time and during the same time period). FIG. 5 shows an example of a storage group volume table. The Monitoring Group ID 57 has Volumes 01:01, 01:02, 02:01, and 02:02.

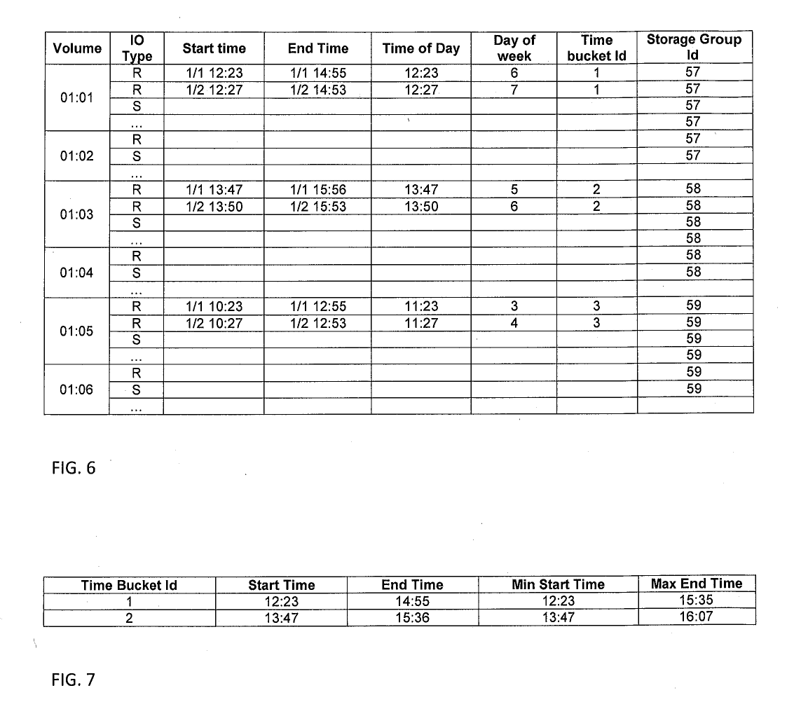

A sustained IO period is a contiguous time period during which a volume has same IO Type (random, sequential, or mixed). The sustained IO period is defined for each volume and it may or may not be repetitive. FIG. 6 shows an example of a SRE (SLO Recommendation Engine) sustained IO table. For each volume, the table shows IO Type (random, sequential), Start Time, End Time, Time of Day (calculated from the start time value), Day of Week (calculated from the start time value), Time Bucket ID, and Storage Group ID. The time bucket ID represents a grouping based on time and a window (e.g., a one-hour window of ±30 minutes). FIG. 7 shows an example of a SRE time bucket table. For each Time Bucket ID, the table shows Start Time, End Time, Minimum Start Time, and Maximum End Time.

A monitoring window is a time period during which all volumes of a monitoring group show the same IO workload (random or sequential). The monitoring window is typically repetitive (e.g., it occurs during the same time every day or during the same time on a specific day of the week).

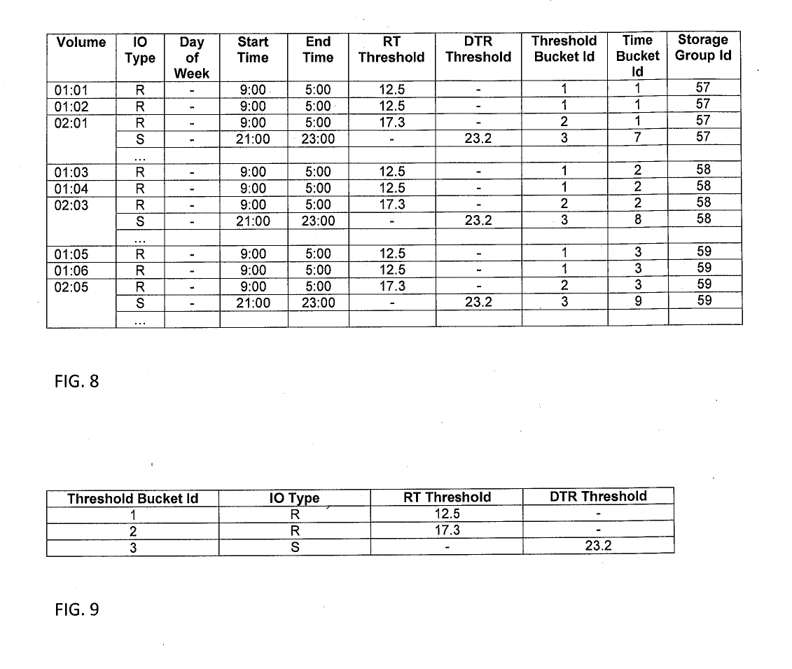

FIG. 8 shows an example of a SRE recommendation table. For each volume, the table shows IO Type, Day of Week (blank means daily pattern), Start Time, End Time, RT (response time) Threshold (blank for sequential IO), DTR (data throughput rate) Threshold (blank for random IO), Threshold Bucket ID, Time Bucket ID, and Storage Group ID. The Threshold Bucket ID represents a grouping based on threshold values. FIG. 9 shows an example of a SRE threshold bucket table. For each Threshold Bucket ID, the table shows IO Type, RT Threshold, and DTR Threshold.

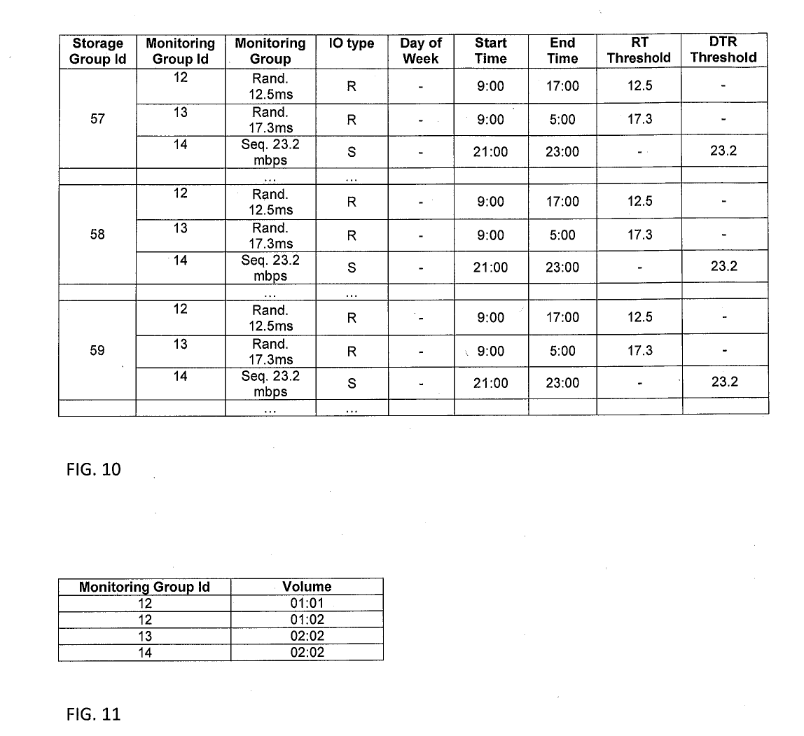

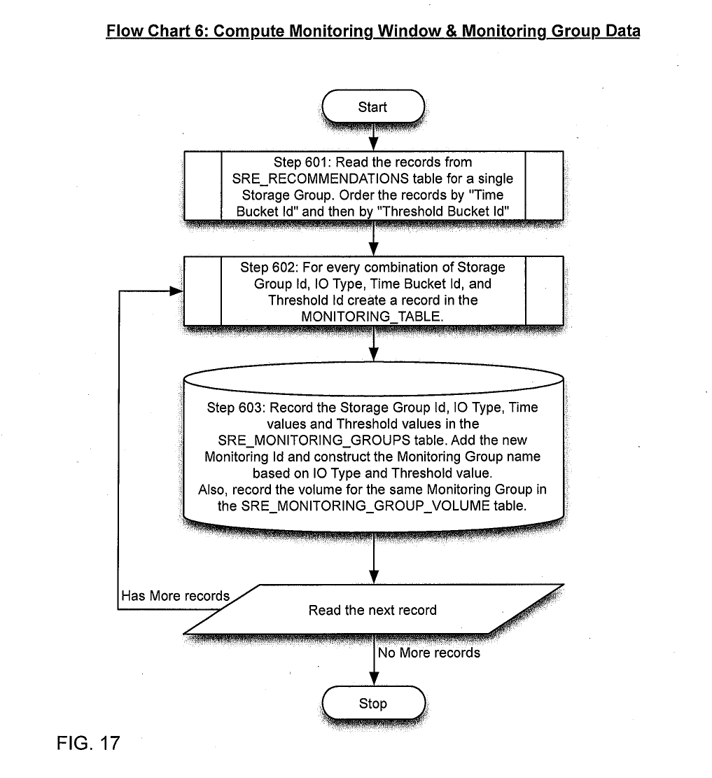

FIG. 10 shows an example of a SRE recommended monitoring groups table. For each Storage Group ID, the table showing Monitoring Group ID, Monitoring Group, IO Type, Day of Week, Start Time, End Time, RT Threshold, and DTR Threshold. In the example shown in FIG. 10, there are multiple Monitoring Group IDs representing multiple monitoring groups in each Storage Group represented by each Storage Group ID. In some cases, as explained below in connection with FIG. 17, a Storage Group may have only one Monitoring Group (i.e., all volumes within the same storage group are included in one monitoring group). This table is reorganized based on Storage Group ID using the SRE recommendation table of FIG. 8 which is organized based on Volume. FIG. 11 shows an example of a SRE monitoring group volume table which lists Monitoring Group ID and Volume.

### First Embodiment

The first embodiment is presented to show the analysis of historical performance data for determining SLO parameters (thresholds and periodicity of monitoring windows) and analysis of real-time performance data to determine which SLO should be used for monitoring the health.

Three assumptions are used. The first assumption relates to the determination of IO type for a single data point. For any performance data snapshot, IO type determination will be made using the following scale

1. Sequential IO if Random IO % is between 0%-40%.

2. Mixed IO if Random IO % is between 40% and 60%.

3. Random IO if Random IO % is greater than 60%.

The second assumption relates to IO Type to SLO type mapping, i.e., determining the applicable SLO types. Predominantly Random IO should be monitored using “Response Time” or RT threshold. Predominantly Sequential IO should be monitored using “Data Throughput rate” or DTR threshold. The rationale is that typically sequential IO is observed for batch processing operations (e.g., backups, data ingestion for data warehousing, etc.). The time taken to complete these operations is a critical factor. There are of course other IO types.

The third assumption relates to determination of sustained IO. To provide some damping (and not be over sensitive to changing IO type), only sustained IO types will be considered appropriate for monitoring. Thus, a minimum “minimum sustained IO duration threshold” will be specified.

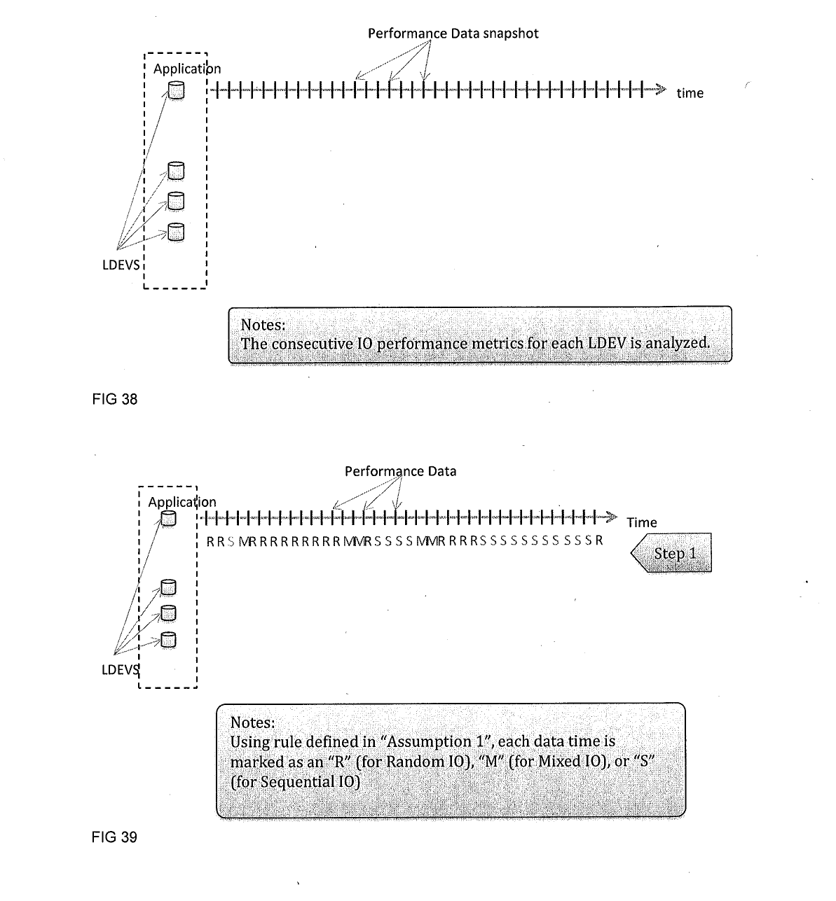

FIG. 38 is a visual illustration of the analysis of historical performance data for determining SLO parameters. It shows performance data snapshots over time for LDEVs of an application. The consecutive IO performance metric for each LDEV is analyzed.

FIG. 39 shows step 1 of the analysis of FIG. 38. Using the rule defined in the first assumption, each data time is marked as an R (for Random IO), M (for Mixed IO), or S (for Sequential IO).

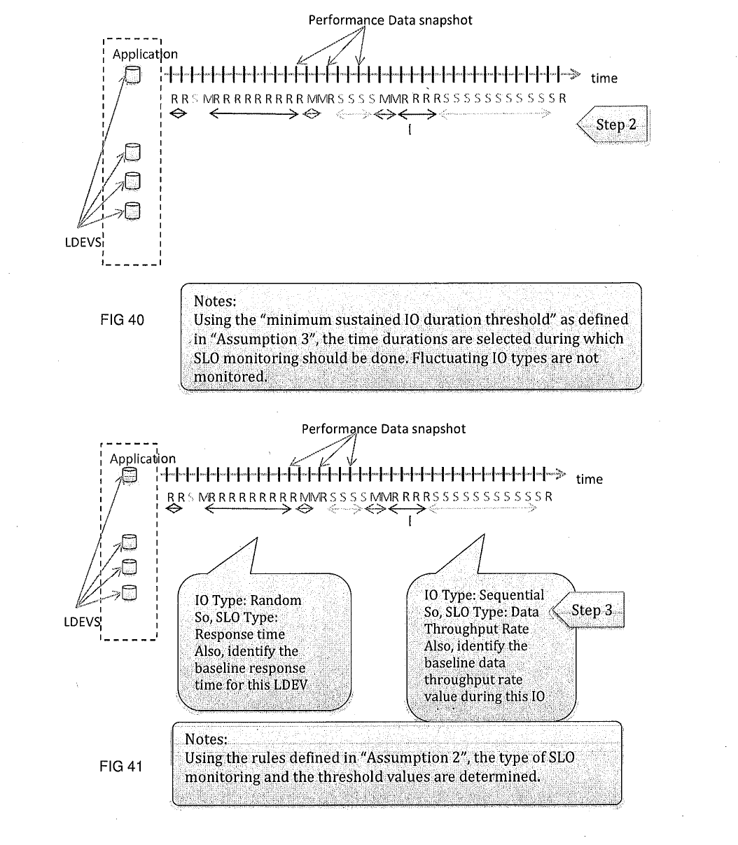

FIG. 40 shows step 2 of the analysis of FIG. 38. Using the “minimum sustained IO duration threshold” as defined in the third assumption, the time durations are selected during which SLO monitoring should be done (indicated by a check mark as opposed to a cross mark). Fluctuating IO types are not monitored.

FIG. 41 shows step 3 of the analysis of FIG. 38. Using the rules defined in the second assumption, the type of SLO monitoring and the threshold values are determined. For Random IO type with Response Time SLO type, the analysis identifies the baseline response time for the particular LDEV. For Sequential IO type with Data Throughput Rate SLO type, the analysis identifies the baseline processing window.

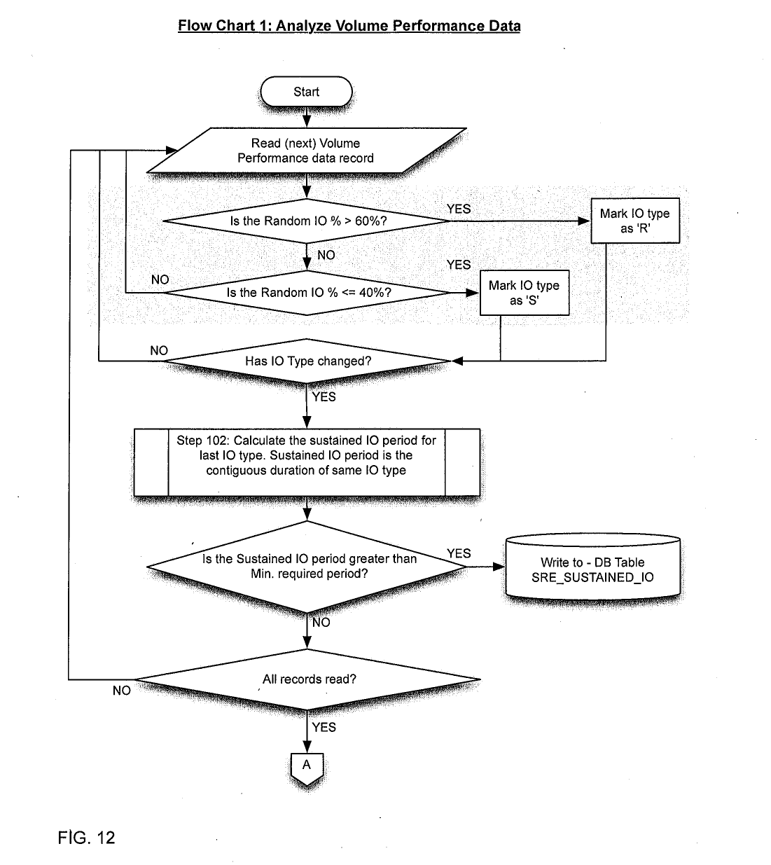

FIG. 12 shows an example of a flow diagram illustrating a process of analyzing volume performance data. The program reads the (next) volume performance data record and determines whether the random IO is over 60%. If yes, it marks the IO type as R (predominantly random). If no, the program determines whether the random IO is less than or equal to 40%. If yes, it marks the IO type as S (predominantly sequential). If no, the program returns to the earlier step to read the next volume performance data record. In the next step, the program determines whether the IO type has changed. If no, the program returns to the earlier step to read the next volume performance data record. If yes, the program calculates the sustained IO period for that volume (step 102). The program then determines whether the sustained IO period is greater than the minimum required period. If yes, the program writes the data to the DB (database) SRE sustained IO table (see FIG. 6). If no, the program returns to the earlier step to read the next volume performance data until all records are read.

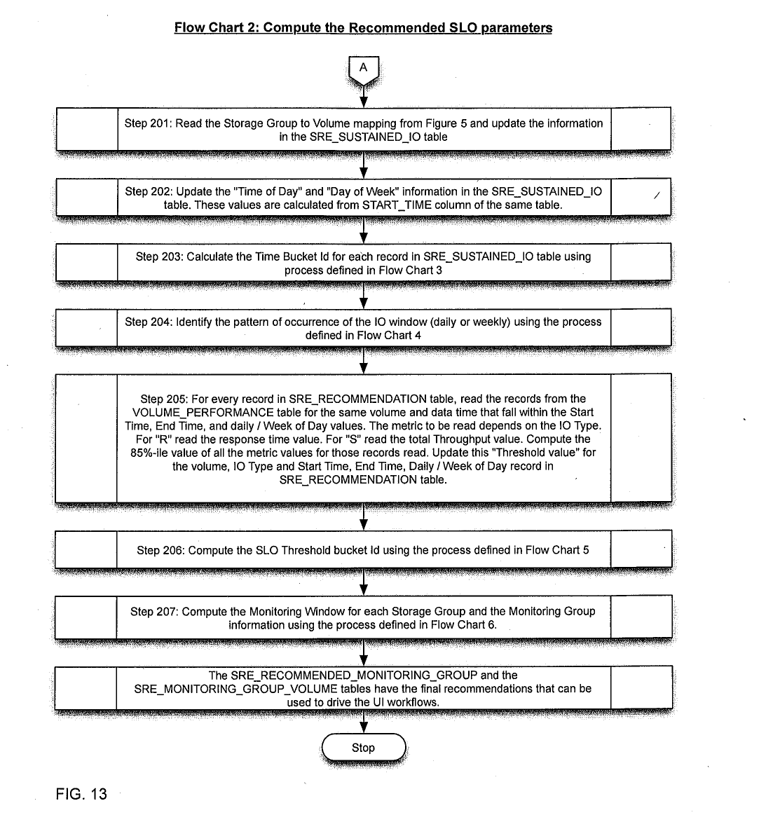

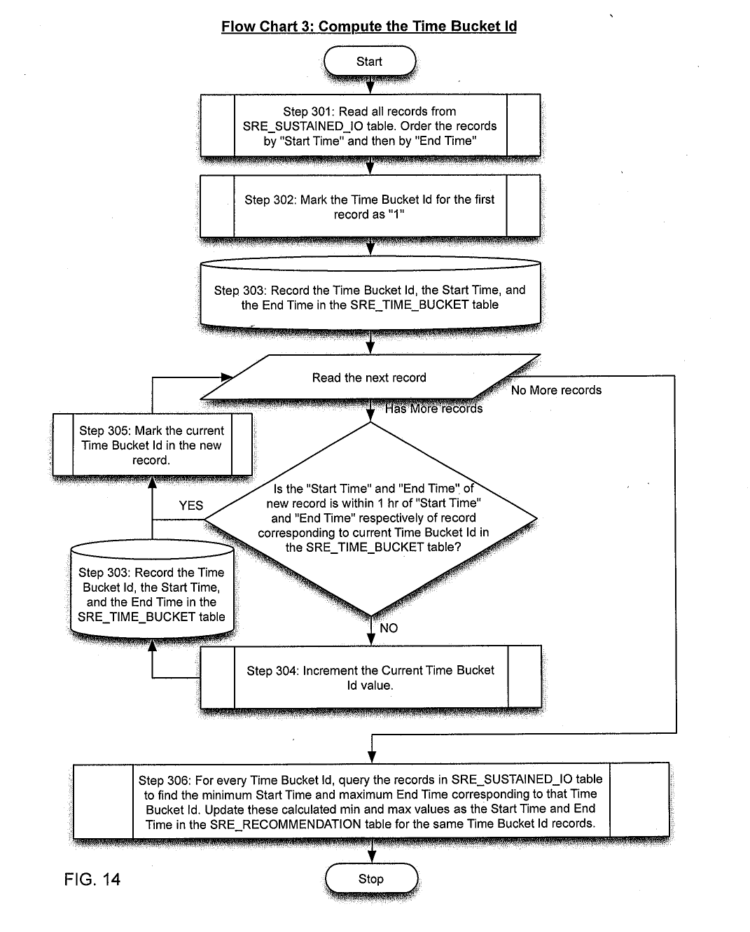

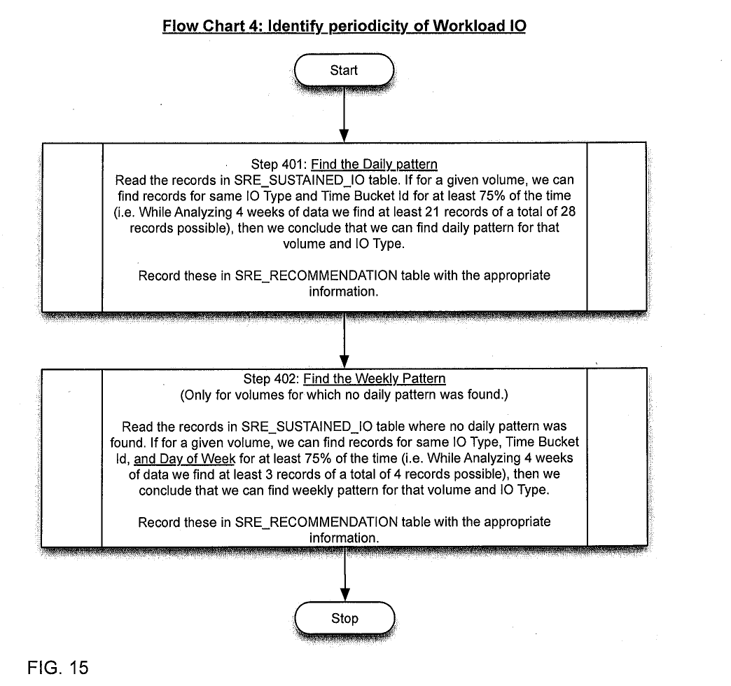

FIG. 13 shows an example of a flow diagram illustrating a process of computing the recommended SLO parameters. In step 201, the program reads the storage group to volume mapping from the storage group volume table (see FIG. 5) and updates the information in the SRE sustained IO table (see FIG. 6). In step 202, the program updates the Time of Day and Day of Week information in the SRE sustained IO table (see FIG. 6). These values are calculated from the Start Time column of the same table. In step 203, the program calculates the Time Bucket ID for each record in the SRE sustained IO table using the process shown in FIG. 14. In step 204, the program identifies the pattern of occurrence of the IO window (daily or weekly) using the process shown in FIG. 15.

In step 205, for every record in the SRE recommendation table (see FIG. 8), the program reads the records from the volume performance table (see FIG. 4) for the same volume and data time that fall within the Start Time, End Time, either every day or on specific days of week as detected during pattern analysis of historical data. The metric to be read depends on the IO Type. For IO Type=R, the program reads the response time value. For IO Type=S, the program reds the total throughput value. The program computes the 85 percentile value of all the metric values for those records read. The program updates this “Threshold Value” for the Volume, IO Type, and Start Time, End Time, and Daily/Week of Day record in the SRE recommendation table (see FIG. 8).

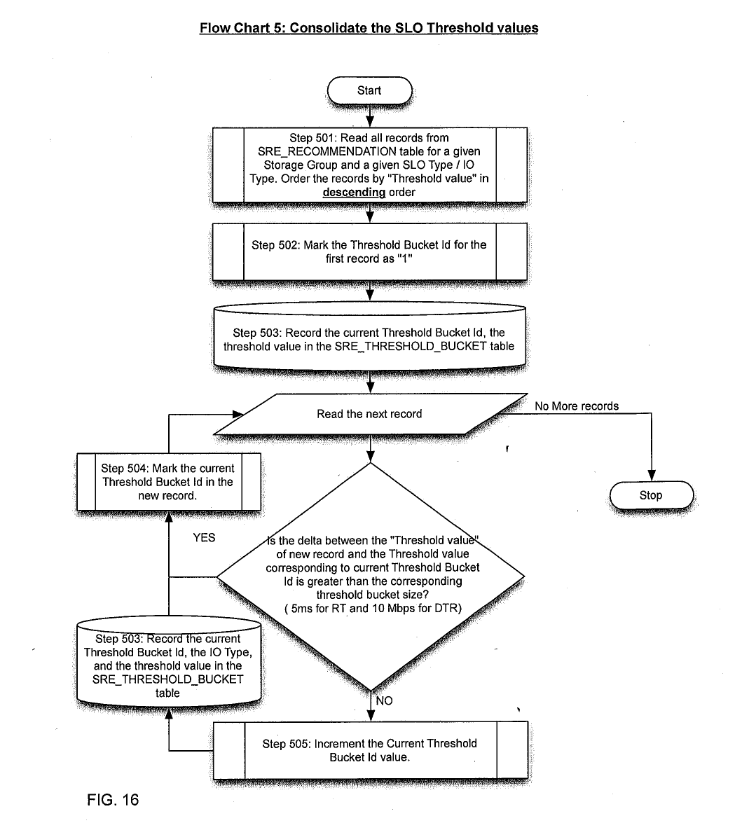

In step 206, the program computes the SLO Threshold Bucket ID using the process shown in FIG. 16. In step 207, the program computes the Monitoring Window for each Storage Group and the Monitoring Group information using the process shown in FIG. 17. The SRE recommended monitoring group table (see FIG. 10) and SRE monitoring group volume table (see FIG. 11) have the final recommendations that can be used to drive the UI (user interface) workflows.

FIG. 14 shows an example of a flow diagram illustrating a process of computing the Time Bucket ID. In step 301, the program reads all records from the SRE sustained IO table (see FIG. 6) and orders the records by Start Time and then by End Time. In step 302, the program marks the Time Bucket ID for the first record as “1.” In step 303, the program records the Time Bucket ID, the Start Time, and the End Time in the SRE time bucket table (see FIG. 7). The program then proceeds to read the next record and determine whether the Start Time and End Time of the new record is within a time bucket size (e.g., one hour) of the Start Time and End Time, respectively, of the record corresponding to the current Time Bucket ID in the SRE time bucket table (see FIG. 7). If yes, the program marks the current Time Bucket ID in the new record (step 305) and returns to the earlier step to read the next record until there are no more records. If no, the program increments the current Time Bucket ID value (step 304), records the current Time Bucket ID, the Start Time, and the End Time in the SRE time bucket table (see FIG. 7) (step 303), marks the current Time Bucket ID in the new record (step 305), and returns to the earlier step to read the next record until there are no more records. When there are no more records to be read, the program proceeds to step 306. In step 306, for every Time Bucket ID, the program queries the records in the SRE sustained IO table (see FIG. 6) to find the minimum Start Time and maximum End Time corresponding to that Time Bucket ID. The program then updates these calculated minimum and maximum values as the Start Time and End Time in the SRE recommendation table (see FIG. 8) for the same Time Bucket ID records.

FIG. 15 shows an example of a flow diagram illustrating a process of identifying periodicity of workload 10. In step 401 to find the daily pattern, the program reads the records in the SRE sustained IO table (see FIG. 6). If for a given Volume, one can find records for the same IO Type and Time Bucket ID for at least 75% of the time (e.g., while analyzing four weeks of data, one can find at least 21 records of a total of 28 records possible), then one concludes that one can find daily pattern for that Volume and IO Type. The program records these in the SRE recommendation table (see FIG. 8) with the appropriate information. In step 402 to find the weekly pattern (only for volumes for which no daily pattern was found), the program reads the records in the SRE sustained IO table (see FIG. 6) where no daily pattern was found. If for a given Volume, one can find records for the same IO Type, Time Bucket ID, and Day of Week for at least 75% of the time (e.g., while analyzing four weeks of data, one can find at least 3 records of a total of 4 records possible), then one concludes that one can find weekly pattern for that Volume and IO Type. The program records these in the SRE recommendation table (see FIG. 8) with the appropriate information.

FIG. 16 shows an example of a flow diagram illustrating a process of consolidating the SLO threshold values. In step 501, the program reads all records from the SRE recommendation table (see FIG. 8) for a given Storage Group and a given SLO Type/IO Type, the program orders the records by “Threshold value” in descending order. For example, the threshold value is RT Threshold for IO Type R or DTR Threshold for IO Type S. In step 502, the program marks the Threshold Bucket ID for the first record as “1.” In step 503, the program records the current Threshold Bucket ID and the threshold value in the SRE threshold bucket table (see FIG. 9). The program then proceeds to read the next record and determine whether the delta (difference) between the threshold value of the new record and the threshold value corresponding to the current Threshold Bucket ID is greater than the corresponding threshold bucket size. For example, the threshold bucket size for RT Threshold is 5 ms and the threshold bucket size for DTR threshold is 10 Mbps. If yes, the program marks the current Threshold Bucket ID in the new record (step 504) and returns to the earlier step to read the next record until there are no more records. If no, the program increments the current Time Bucket ID value (step 505), records the current Threshold Bucket ID, the IO Type, and the threshold value in the SRE threshold bucket table (see FIG. 9) (step 503), marks the current Threshold Bucket ID in the new record (step 504), and returns to the earlier step to read the next record until there are no more records. When there are no more records to be read, the process ends.

FIG. 17 shows an example of a flow diagram illustrating a process of computing monitoring window and monitoring group data. In step 601, the program reads the records from the SRE recommendation table (see FIG. 8) for a single Storage Group, and orders the records by Time Bucket ID and them by Threshold Bucket ID. In step 602, for every combination of Storage Group ID, IO Type, Time Bucket ID, and Threshold Bucket ID, the program creates a record in the monitoring tables (see FIGS. 10 and 11). In step 603, the program records the Storage Group ID, IO Type, time values, and threshold values in the SRE recommended monitoring groups table (see FIG. 10). The program adds the new Monitoring Group ID and constructs the Monitoring Group name in FIG. 10 based on the IO Type and threshold value. A storage group represented by a Storage Group ID may have one or more monitoring groups represented by one or more Monitoring Group IDs. In the example shown in FIG. 10, each Storage Group ID has multiple Monitoring Group IDs. However, if the calculations show that all volumes within the same storage group are included in one monitoring group, then that storage group represented by a Storage Group ID has only one monitoring group represented by one Monitoring Group ID. The program also records the Volume for the same Monitoring Group in the SRE monitoring group volume table (see FIG. 11). The program reads the next record and returns to step 602 until there are no more records and the process ends.

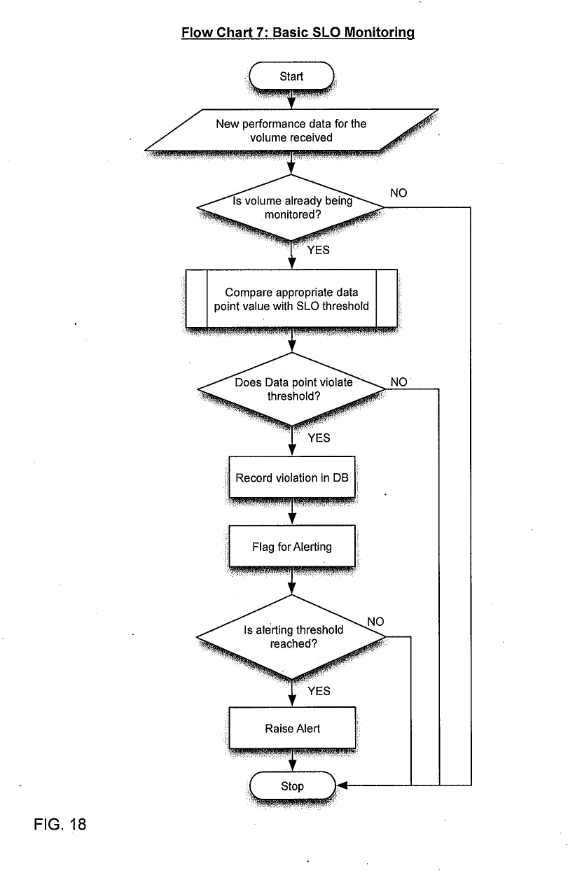

FIG. 18 shows an example of a flow diagram illustrating a process of basic SLO monitoring. To start, new performance data for the volume is received. The program determines whether the volume is already being monitored (e.g., whether the volume is within the monitoring window). If no, the process ends. If yes, the program compares the appropriate data point value with the SLO threshold (e.g., RT threshold or DTR threshold). If the data point does not violate the SLO threshold, the process ends. If the data point violates the SLO threshold, the program records the violation in DB and flags for alerting. If an alerting threshold has not been reached, the process ends. If the alerting threshold has been reached, the program raises the alert and the process ends. The alerting threshold is a preset threshold which may be a preset cumulative number of violations required before raising the alert.

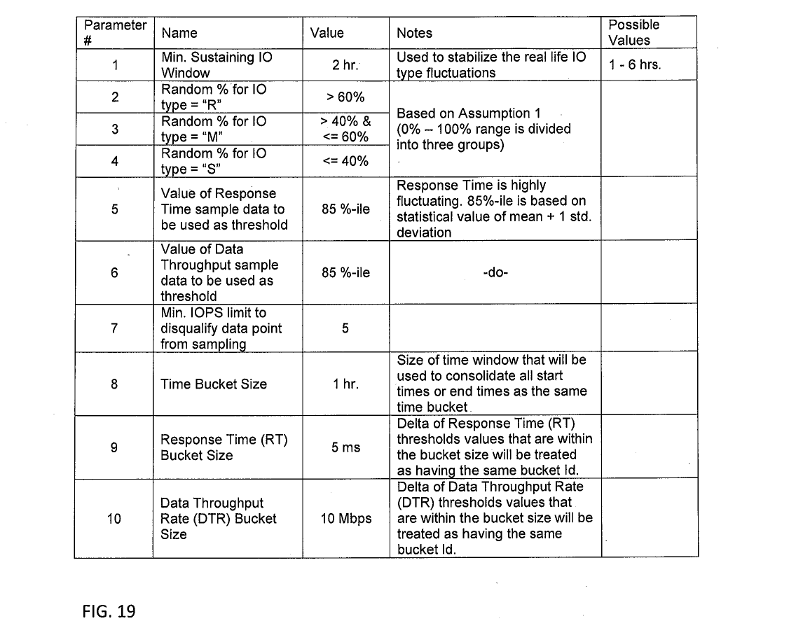

FIG. 19 shows an example of a list of parameters used in this embodiment of the invention. The minimum sustaining IO window (e.g., 2 hours) is used to stabilize the real life IO type fluctuations. The random % for IO type=“R” (e.g., >60%), the random % for IO type=“M” (e.g., >40% and ≦60%), the random % for IO type=“S” (e.g., ≦40%) are based on the first assumption describe above, by which the 0% to 100% range is divided into three groups. The value of Response Time sample data to be used as threshold (e.g., 85 percentile) is used to indicate highly fluctuating Response Time. In this example, the 85 percentile is determined based on statistical value of mean+1 standard deviation. The value of Data Throughput sample data to be used as threshold is also 85 percentile in this example. The minimum IOPS limit to disqualify data point from sampling is 5 in the example. The time bucket size (e.g., 1 hour) is the size of time window that will be used to consolidate all start times or end times as the same time bucket. As the Response Time (RT) bucket size (e.g., 5 ms), the delta of RT threshold values that are within the bucket size will be treated as having the same Threshold Bucket ID. As the Data Throughput Rate (DTR) bucket size, the delta of DTR threshold values that are within the bucket size will be treated as having the same Threshold Bucket ID.

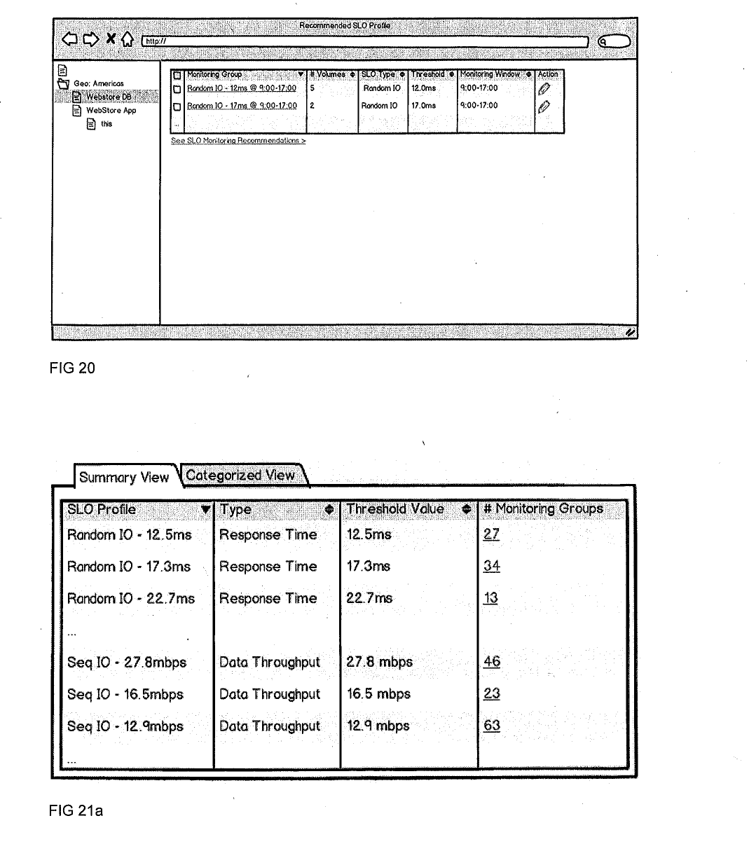

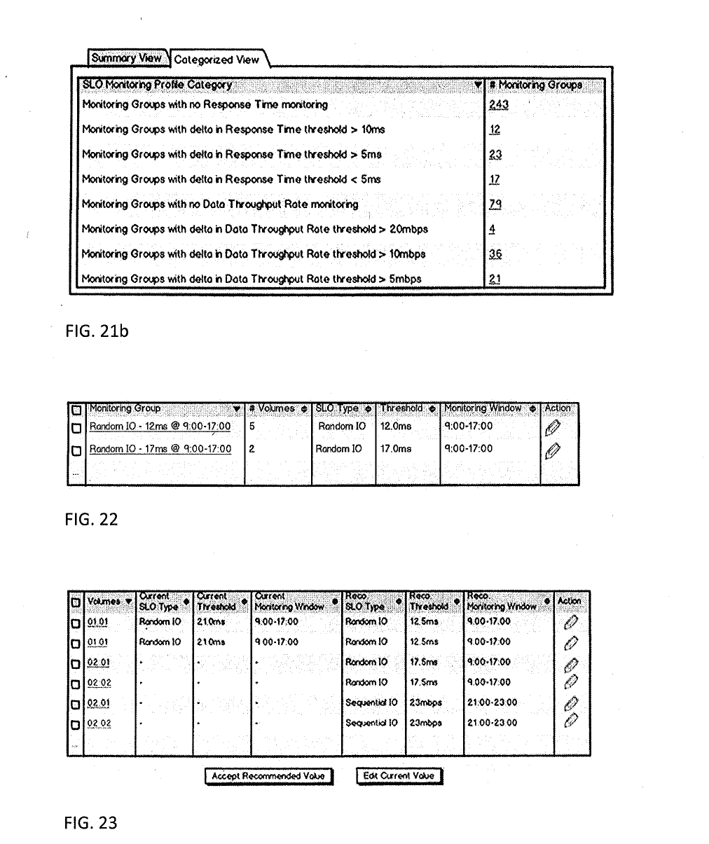

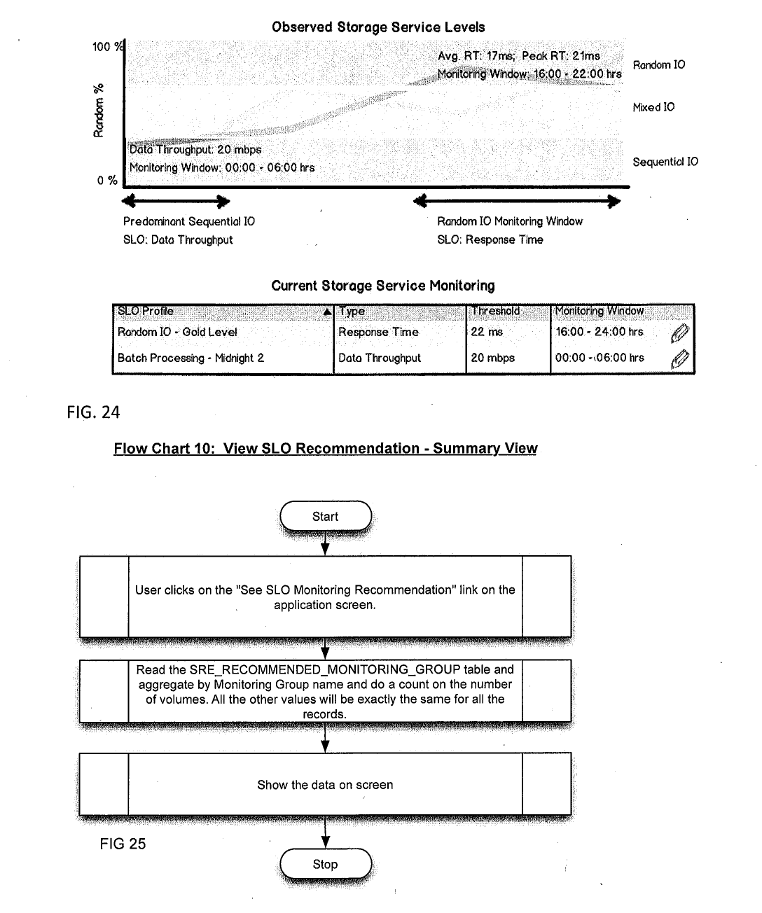

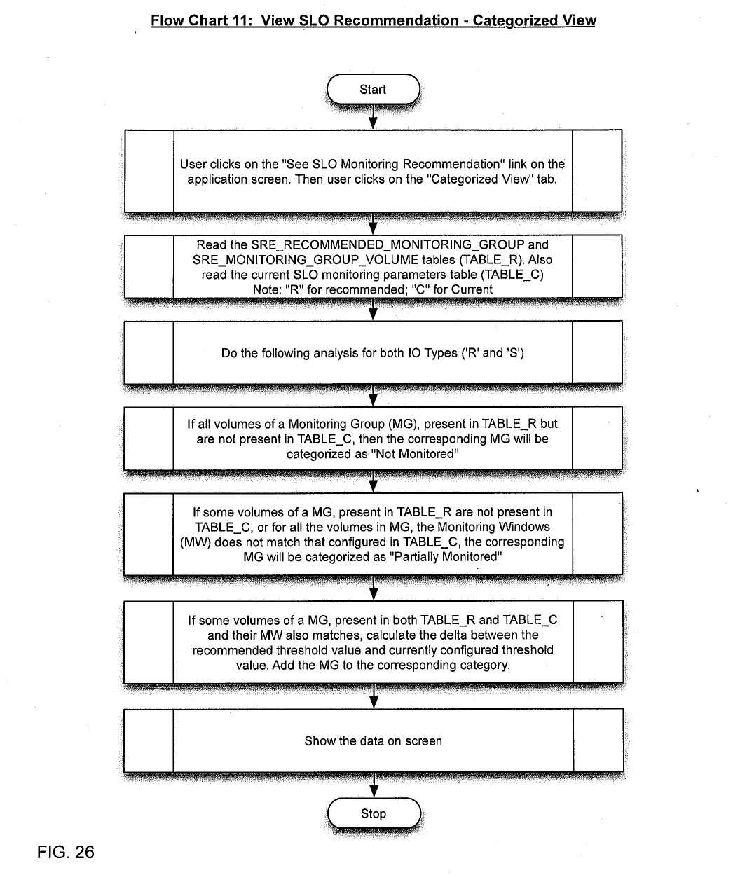

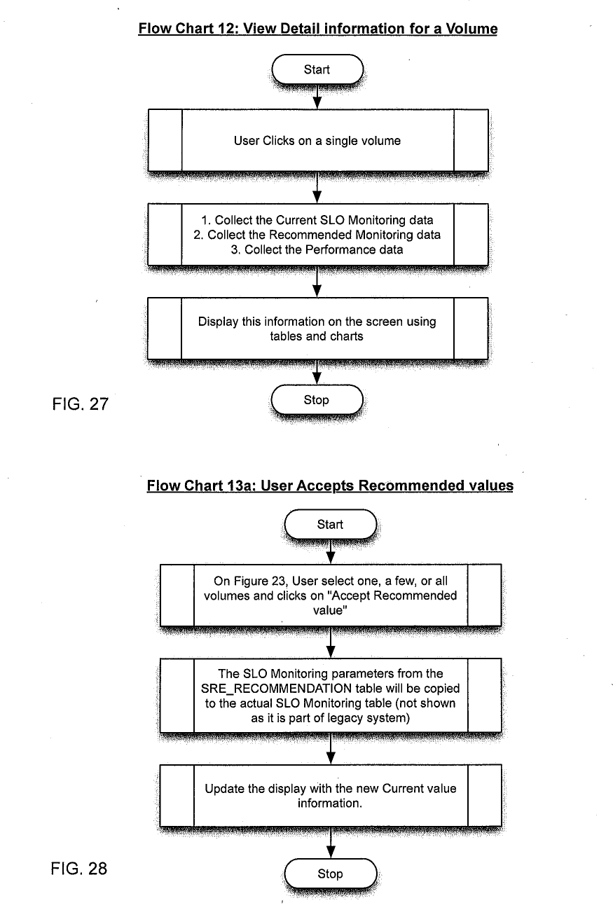

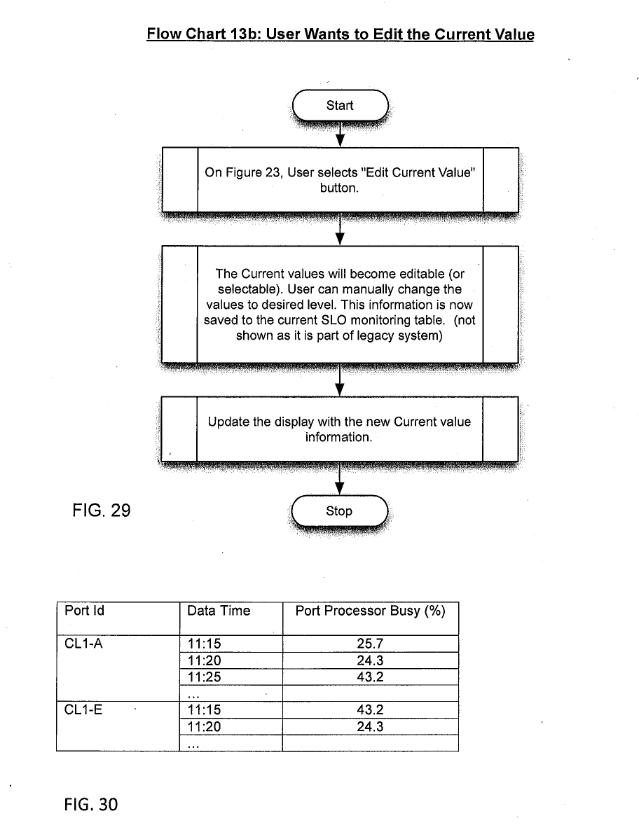

FIG. 20 shows an example of an application UI (user interface). The application UI in this example presents a table showing Monitoring Group, Volumes, SLO Type, Threshold, Monitoring Window, and Action. The user can select one of the Monitoring Groups or selection an Action relating to the Monitoring Groups. Similar information is found in the SRE recommended monitoring groups table (FIG. 10) and SRE monitoring group volume table (FIG. 11). Clicking on a “See SLO Monitoring Recommendations” link launches the screens in FIGS. 21a (summary view of SLO recommendations) and 21b (categorized view of SLO recommendations). Clicking on a specific Monitoring Group name launches the screen in FIG. 23 (view and edit SLO parameters for a Monitoring Group).

FIG. 21a shows an example of a screen for summary view of SLO recommendations. The summary view shows columns of SLO Profile, Type, Threshold Value, and # Monitoring Groups. The SLO Profile includes SLO type and threshold value in this example. Clicking on the number in the # Monitoring Groups column launches the screen in FIG. 22 (list of Monitoring Groups).

FIG. 21b shows an example of a screen for categorized view of SLO recommendations. The categorized view shows columns of SLO Monitoring Profile Category and # Monitoring Groups. Examples of SLO Monitoring Profile Category are “Monitoring Groups with no Response Time monitoring,” “Monitoring Groups with delta in Response Time threshold>10 ms,” and “Monitoring Groups with delta in Data Throughput Rate threshold>10 Mbps.” Again, clicking on the # monitoring Groups column launches the screen in FIG. 22.

FIG. 22 shows an example of a screen for list of monitoring groups. The table in this example has columns of Monitoring Group, # Volumes, SLO Type, Threshold, Monitoring Window, and Action. Again, clicking on a specific Monitoring Group name launches the screen in FIG. 23.

FIG. 23 shows an example of a screen for view and edit SLO parameters for a monitoring group. The table in this example has columns of Volumes, Current SLO Type, Current Threshold, Current Monitoring Window, Recommended SLO Type, Recommended Threshold, Recommended Monitoring Window, and Action. Clicking on a specific volume launches the screen in FIG. 24 (review SLO recommendation for a volume).

FIG. 24 shows an example of a view of a screen for review SLO recommendation for a volume. The screen shows observed storage service levels for a monitoring window. The random % axis is divided into random IO, mixed IO, and sequential IO. The time axis includes predominantly sequential IO monitoring window (SLO: Data Throughput Rate) and predominantly random IO monitoring window (SLO: Response Time). The screen also shows current storage service monitoring presented in a table having columns of SLO Profile, Type, Threshold, and Monitoring Window. Examples of SLO Profile include Random IO—Gold Level and Batch Processing—Midnight 2.

FIG. 25 shows an example of a flow diagram illustrating a process for displaying the view of SLO recommendation—summary view (see FIG. 21a). To start, the user clicks on the “See SLO Monitoring Recommendation” link on the application screen (see FIG. 20). The program reads the SRE recommended monitoring groups table (see FIG. 10), aggregates by Monitoring Group name, and does a count on the number of volumes. All the other values will be exactly the same for all the records. The program shows the data on screen (see FIG. 21a).

FIG. 26 shows an example of a flow diagram illustrating a process for displaying the view of SLO recommendation—categorized view (see FIG. 21b). To start, the user clicks on the “See SLO Monitoring Recommendation” link on the application screen (see FIG. 20) and then the “Categorized View” tab (see FIG. 21b). The program reads the SRE recommended monitoring groups table (see FIG. 10) and the SRE monitoring group volume table (see FIG. 11) (referred to collectively as Table R; R stands for “recommended”), and reads the current SLO monitoring parameters table (see, e.g., Current Storage Service Monitoring table in FIG. 24) (referred to as Table C; C stands for “current”). The program proceeds to perform the following analysis for both IO types (R (random) and S (sequential)). If all volumes of a Monitoring Group (MG) are present in Table R but are not present in Table C, then the corresponding MG will be categorized as “Not Monitored.” If some volumes of a MG are present in Table R but are not present in Table C, or for all the volumes in a MG, the Monitoring Windows (MW) does not match that configured in Table C, the corresponding MG will be categorized as “Partially Monitored.” If some volumes of a MG are present in both Table R and Table C and their MW also matches, the program calculates the delta between the recommended threshold value and the currently configured threshold value, and adds the MG to the corresponding category. The program then shows the data on the screen (see FIG. 21b).

FIG. 27 shows an example of a flow diagram illustrating a process for viewing detail information for a volume. To start, the user clicks on a single volume. The program (1) collects the current SLO monitoring data, (2) collects the recommended monitoring data, and (3) collects the performance data. The program displays the collected information on the screen using tables and charts. Examples of recommend and current data are shown in FIGS. 21a, 21b, and 24.

FIG. 28 shows an example of a flow diagram illustrating a process for a user to accept SLO recommendation values. To start, the user selects, from the screen display for view and edit SLO parameters for a monitoring group in FIG. 23, one, a few, r all volumes and clicks on “Accept Recommended Value.” The SLO monitoring parameters from the SRE recommendation table (see FIG. 8) will be copied to the actual SLO monitoring table (which may be similar in construction to the recommendation table but contain actual parameters and values). The program updates the display with the new current value information.

FIG. 29 shows an example of a flow diagram illustrating a process for a user to edit current values. To start, the user selects, from the screen display for view and edit SLO parameters for a monitoring group in FIG. 23, one, a few, or all volumes and clicks on “Edit Current Value.” The current values will become editable (or selectable). The user can manually change the values to the desired numbers/levels. This information is now saved to the current SLO monitoring table (which may be similar in construction to the recommendation table but contain current parameters and values). The program updates the display with the new current value information.

### Second Embodiment

In the second embodiment, the algorithm is modified to take into account the internal state of the Storage System Components. For example, when some of the components are known to operate at a level that degrades the overall performance, those corresponding data points (RT and DTR) are not considered in the sample data. This ensures that the sample data is truly representative of the normal operating conditions of the Storage System. Specific cases considered as examples include the following:

1. When Port microprocessor utilization is high (e.g., over 65%), the Storage System is designed to slow down the performance so as not to flood the system and maintain data integrity (even at lower performance). FIG. 30 shows an example of port performance data. It lists, for each Port ID, Data Time and Port Processor Busy (%). FIG. 32 shows an example of port to volume mapping data. It lists, for each Port ID, one or more HSD (Host Storage Domain) IDs and, for each HSD ID, one or more Volume ID.

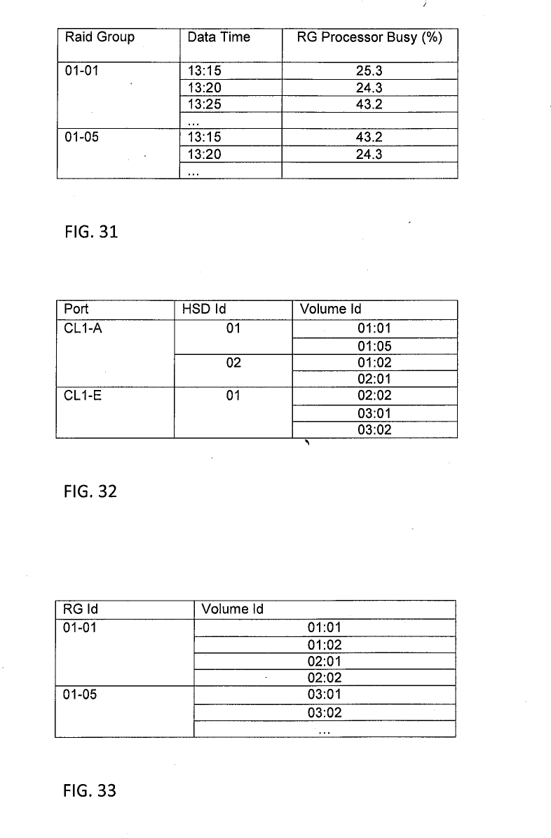

2. When Back-end microprocessors (controlling the RAID Groups) reach high utilization (e.g., above 85%), it affects the performance of the IO. Again, in such cases, the corresponding data points are not considered as part of the sample data for threshold calculation. FIG. 31 shows an example of RAID Group performance data. It lists, for each RAID Group, Data Time and RG Processor Busy (%). FIG. 33 shows an example of RAID Group to volume mapping data. It lists, for each RG ID, Volume IDs.

3. When there is very little 10 (e.g., <5 IOPS), the recorded metric does not seem to be accurate. In such cases, those data points are not considered in the sample data.

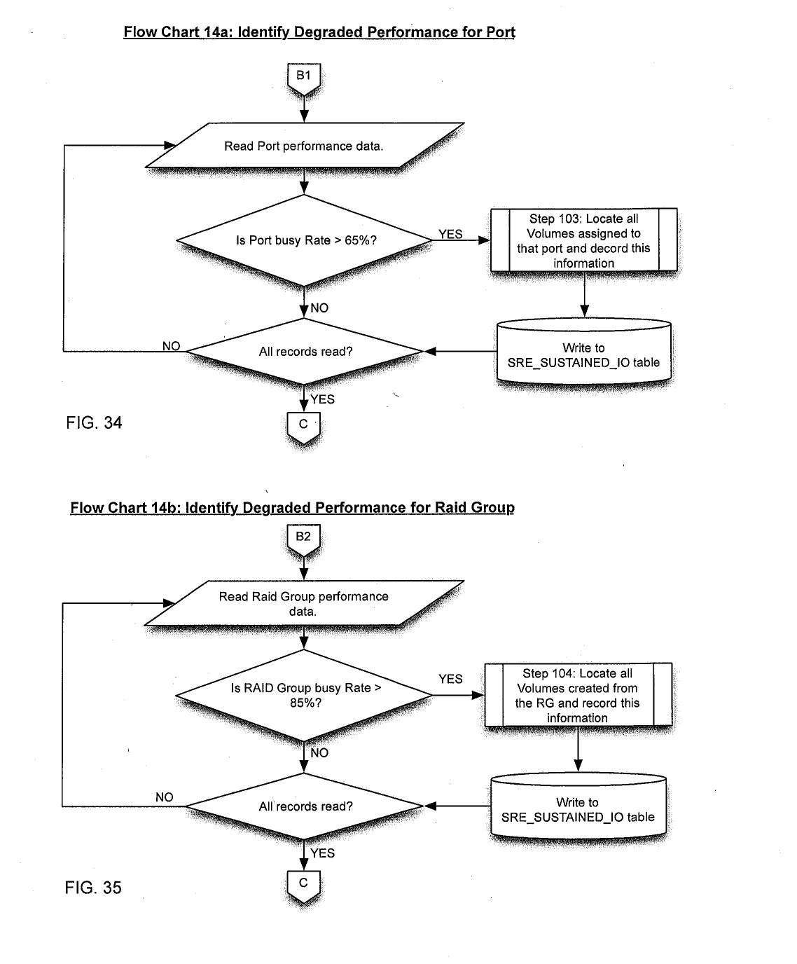

FIG. 34 shows an example of a flow diagram illustrating a process for identifying degraded performance for port. The program reads port performance data (see FIG. 30) and checks whether the Port busy rate is greater than 65% or not. If yes, the program locates all Volumes assigned to that Port (see FIG. 32) and records this information (step 103), and writes to the SRE sustained IO table (see FIG. 6). In both cases, the program checks whether all records have been read and returns to the earlier step to read port performance data until all records are read.

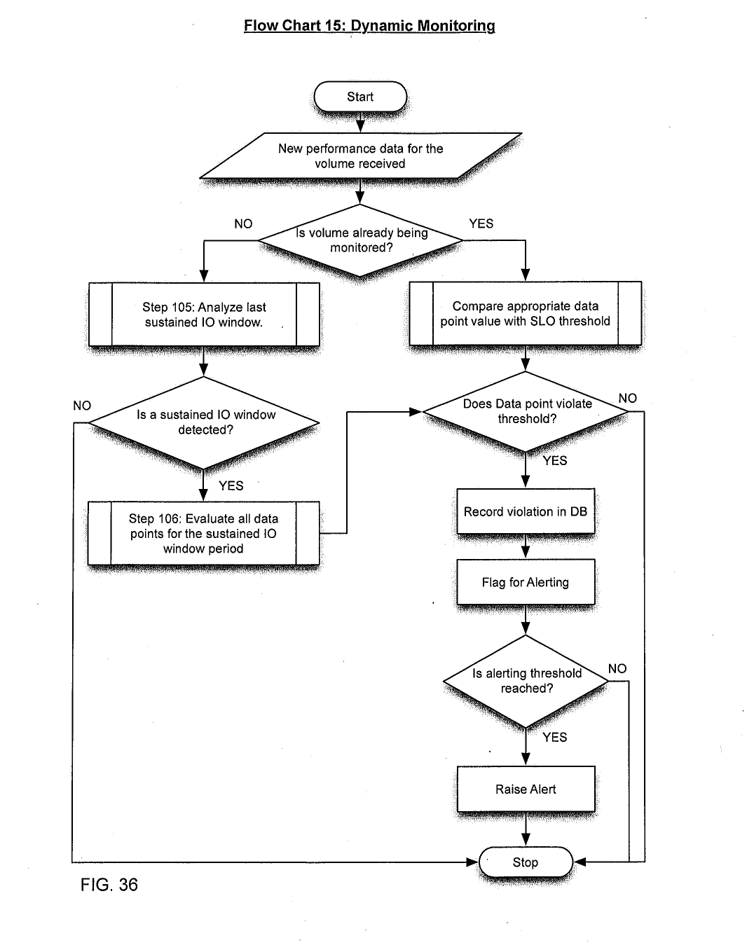

FIG. 35 shows an example of a flow diagram illustrating a process for identifying degraded performance for RAID Group. The program reads RAID Group performance data (see FIG. 31) and checks whether the RAID Group busy rate is greater than 85% or not. If yes, the program locates all Volumes created from the RG (see FIG. 33) and records this information (step 104), and writes to the SRE sustained IO table (see FIG. 6). In both cases, the program checks whether all records have been read and returns to the earlier step to read port performance data until all records are read.

### Third Embodiment

In the third embodiment, the SLO monitoring is not only during the identified monitoring windows for each Storage Groups and Monitoring Groups. The volume 10 is constantly monitored. As soon as a sustained IO of a specific type is identified, that sustained IO for that volume is monitored using pre-established SLO threshold values.

FIG. 36 shows an example of a flow diagram illustrating a process for dynamic monitoring. The program receives new performance data for the Volume and checks whether the Volume is already being monitored or not. If yes, the program compares appropriate data point value with SLO threshold. If no, the program tries to determine if it should start monitoring the Volume. The trigger to start monitoring a Volume is to check if the volume has had a sustained IO period greater than the minimum threshold (for sustained IO). In step 105, the program tries to calculate the duration of its sustained IO (including the past IO data points). If sustained IO period is detected, based on the IO type, the program determines which SLO monitoring should be employed (RT or DTR) and what threshold value should be used for monitoring given the historical threshold value for that Volume. This SLO monitoring is then applied to all the data points in the detected sustained IO window period (step 106). If no, the process ends.

Subsequently (after comparing appropriate data point value (service level value for sustained IO window) with SLO threshold for already monitored Volume or after step 106), the program determines whether Data point violates the threshold. If no, the process ends. If yes, the program records the violation in DB, flags for alerting, and determines whether the alerting threshold (e.g., a preset cumulative number of violations before reaching the alerting threshold) has been reached or not. If no, the process ends. if yes, the program raises alert.

Of course, the system configuration illustrated in FIG. 1 is purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for dynamic storage service level monitoring. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

1.-21. (canceled)

21. A management computer which is coupled to a storage system providing a plurality of storage volumes to one or more servers, the management computer comprising:
a memory storing Input/Output (I/O) information, of a storage volume in the plurality of storage volumes, which is derived from the storage system, the I/O information including a number of I/Os by I/O type and plural types of I/O performance values; and
a processor configured to:
determine, for the storage volumes, a first type of Service Level Objective (SLO) which should be used to monitor the storage volume based on the number of I/Os by I/O type to the storage volume,
determine, for the storage volume, a threshold value for the determined first type of SLO based on a first type of an I/O performance value of the storage volume, wherein the first type of the I/O performance value included in the plural types of I/O performance values is associated with the determined first type of SLO, and
recommend the determined first type of SLO and the determined threshold value for the first type of SLO which should be used for monitoring the storage volume.

22. A management computer according to claim 21,
wherein the number of I/Os by I/O type is a number of random I/O and a number of sequential I/O, and
wherein the processor determines the first type of SLO as either repose time or data through put rate based on the number of random I/O and the number of sequential I/O.

23. A management computer according to claim 21,
wherein the number of I/Os by I/O type is a number of random I/O and a number of sequential I/O, and
wherein the processor determines the first type of SLO as either repose time or data throughput rate based on ratio of the number of random I/O.

24. A management computer according to claim 21,
wherein if the processor determines the first type of SLO is repose time, the processor is configured to determine the threshold value for the response time to the storage volume based on the response time to the storage volume within a periodic monitoring window, and
wherein if the processor determines the first type of SLO is data throughput rate, the processor is configured to determine the threshold value for the data throughput rate to the storage volume based on the data throughput rate to the storage volume within the periodic monitoring window.

25. A management computer according to claim 21,
wherein the processor is configured to create a storage group which is a group of one or more first storage volumes, in the plurality of storage volumes, which are provisioned to the same serve in the one or more servers, and create monitoring group under the storage group which is a group of one or more storage volumes, in the one or more first storage volume, which are determined to have the same type of SLO and the same threshold value which should be used for monitoring the one or more storage volume.

26. A management computer according to claim 25,
wherein the processor is configured to display the determined first type of SLO and the determined threshold value for the first type of SLO by the monitoring group in the storage group.

27. A management computer which is coupled to a storage system providing a plurality of storage volumes to one or more servers, the management computer:
a memory storing Input/Output (I/O) information of each of the storage volumes in the storage system, the I/O information including the number of random and sequential I/O and plural types of I/O performance values; and
a processor being configured to:
determine, for a storage volume of plurality of storage volumes, a type of Service Level Objective (SLO) which should be used to monitor the storage volume based on the number of random and sequential I/O to the storage volume,
determine, for the storage volume, a threshold value for the determined type of SLO based on a type of a I/O performance value of the storage volume, wherein the type of the I/O performance value of the plural types of I/O performance is related to the determined type of SLO, and
recommend the determined type of SLO and the determined threshold value for the determined type of SLO which should be used for monitoring the storage volume.

28. A management computer according to claim 27,
wherein the processor determines the type of SLO as either repose time or data throughput rate based on ratio of the number of random I/O.

29. A management computer according to claim 28,
wherein if the processor determines the type of SLO is a repose time, the processor is configured to determine the threshold value for the response time to the storage volume based on the response time to the storage volume within a periodic monitoring window, and
wherein if the processor determines the type of SLO is data throughput rate, the processor is configured to determine the threshold value for the data throughput rate to the storage volume based on the data throughput rate to the storage volume within the periodic monitoring window.

30. A management computer according to claim 28,
wherein the processor is configured to create a storage group which is a group of one or more first storage volumes, in the plurality of storage volumes, which are provisioned to the same serve in the one or more servers, and create monitoring group under the storage group, which is a group of one or more storage volumes, in the one or more first storage volume, which are determined to have the same type of SLO and the same threshold value which should be used for monitoring the one or more storage volume.

31. A management computer according to claim 30,
wherein the processor is configured to display the determined type of SLO and the determined threshold value for the type of SLO by the monitoring group in the storage group.

32. A method for a management computer which is coupled to a storage system providing a plurality of storage volumes to one or more servers, the method comprising:
storing Input/Output (I/O) information, of a storage volume in the plurality of storage volumes, which is derived from the storage system, the I/O information including a number of I/Os by I/O type and plural types of I/O performance values; and
determining, for the storage volumes, a first type of Service Level Objective (SLO) which should be used to monitor the storage volume based on the number of I/Os by I/O type to the storage volume,
determining, for the storage volume, a threshold value for the determined first type of SLO based on a first type of an I/O performance value of the storage volume, wherein the first type of the I/O performance value included in the plural types of I/O performance values is associated with the determined first type of SLO, and
recommending the determined first type of SLO and the determined threshold value for the first type of SLO which should be used for monitoring the storage volume.

33. A method according to claim 32, wherein the number of I/Os by I/O type is a number of random I/O and a number of sequential I/O, further comprising:
determining the first type of SLO as either repose time or data through put rate based on the number of random I/O and the number of sequential I/O.

34. A method according to claim 32, wherein the number of I/Os by I/O type is a number of random I/O and a number of sequential I/O, further comprising:
determining the first type of SLO as either repose time or data throughput rate based on ratio of the number of random I/O.

35. A method according to claim 32, further comprising:
determining, if the processor determines the first type of SLO is repose time, the threshold value for the response time to the storage volume based on the response time to the storage volume within a periodic monitoring window,
determining, if the processor determines the first type of SLO is data throughput rate, the threshold value for the data throughput rate to the storage volume based on the data throughput rate to the storage volume within the periodic monitoring window.

36. A method according to claim 36, further comprising:
creating a storage group which is a group of one or more first storage volumes, in the plurality of storage volumes, which are provisioned to the same serve in the one or more servers; and
creating monitoring group under the storage group which is a group of one or more storage volumes, in the one or more first storage volume, which are determined to have the same type of SLO and the same threshold value which should be used for monitoring the one or more storage volume.

37. A method according to claim 36, further comprising:
displaying the determined first type of SLO and the determined threshold value for the first type of SLO by the monitoring group in the storage group.
